(19) United States
(12) Patent Application Publication
(10) Pub. No.: US 2023/0237575 A1
(43) Pub. Date: Jul. 27, 2023

(54) SELF-UPDATING TRADING BOT PLATFORM

(71) Applicant: Cryptium Capital, LLC, Demarest, NJ (US)

(72) Inventors: Jun Shimada, New York, NY (US); Jeffrey Jagid, Demarest, NJ (US)

(21) Appl. No.: 18/099,643

(22) Filed: Jan. 20, 2023

Related U.S. Application Data
(60) Provisional application No. 63/301,727, filed on Jan. 21, 2022.

(51) Int. Cl. G06Q 40/04; G06N 5/022

(52) U.S. Cl. CPC G06Q 40/04; G06N 5/022

(57) ABSTRACT

A computing system generates a plurality of trading bots. Each trading bot includes a plurality of parameters that characterize the trading bot. The plurality of parameters define execution rules for the trading bot. The computing system retrieves historical data associated with a financial asset from one or more third party systems. The computing system searches the plurality of trading bots for an initial ideal trading bot that tracks a performance of the financial asset based on the historical data. The computing system deploys the initial ideal trading bot for a first duration of time. The computing system evaluates the performance of the initial ideal trading bot for the first duration of time. Based on the evaluating, the computing system searches the plurality of trading bots based on the initial ideal trading bot. Based on the searching, the computing system deploys a new ideal trading bot for a second duration of time.

### FIELD OF THE DISCLOSURE

Embodiments disclosed herein generally relate to an automated trading platform and, more specifically, to an automated trading platform having self-updating trading bots.

### BACKGROUND

With the increasing number of electronic trading application and electronic exchange systems, the ability to buy, sell, or trade financial assets has never been more available to end users. While access to electronic trading applications and electronic exchanges systems allow for more access to these functionalities, buying, selling, and trading financial assets is an art in and of itself. Identifying the right asset strategy is far from trivial. Attempts to automate such process typically leaves much lot to be desired.

### SUMMARY

In some embodiments, a method is disclosed herein. A computing system generates a plurality of trading bots. Each trading bot includes a plurality of parameters that characterize the trading bot. The plurality of parameters define execution rules for the trading bot. The computing system retrieves historical data associated with a financial asset from one or more third party systems. The computing system searches the plurality of trading bots for an initial ideal trading bot that tracks a performance of the financial asset based on the historical data. The computing system deploys the initial ideal trading bot for a first duration of time. When deployed, the initial ideal trading bot executes the execution rules associated with the plurality of parameters that define the initial ideal trading bot. The computing system evaluates the performance of the initial ideal trading bot for the first duration of time. Based on the evaluating, the computing system searches the plurality of trading bots based on the initial ideal trading bot. The searching includes favoring a first set of trading bots that are similar to the initial ideal trading bot or penalizing the first set of trading bots that are similar to the initial ideal trading bot. Based on the searching, the computing system deploys a new ideal trading bot for a second duration of time.

In some embodiments, a non-transitory computer readable medium is disclosed herein. The non-transitory computer readable medium includes one or more sequences of instructions, which, when executed by one or more processors, causes a computing system to perform operations. The operations include generating, by the computing system, a plurality of trading bots. Each trading bot includes a plurality of parameters that characterize the trading bot. The plurality of parameters defines execution rules for the trading bot. The operations further include retrieving, by the computing system, historical data associated with a financial asset from one or more third party systems. The operations further include searching, by the computing system, the plurality of trading bots for an initial ideal trading bot that tracks a performance of the financial asset based on the historical data. The operations further include deploying, by the computing system, the initial ideal trading bot for a first duration of time. When deployed, the initial ideal trading bot executes the execution rules associated with the plurality of parameters that define the initial ideal trading bot. The operations further include evaluating, by the computing system, the performance of the initial ideal trading bot for the first duration of time. The operations further include, based on the evaluating, searching, by the computing system, the plurality of trading bots based on the initial ideal trading bot. The searching includes favoring a first set of trading bots that are similar to the initial ideal trading bot or penalizing the first set of trading bots that are similar to the initial ideal trading bot. The operations further include, based on the searching, deploying, by the computing system, a new ideal trading bot for a second duration of time.

In some embodiments, a system is disclosed herein. The system includes a processor and a memory. The memory has programming instructions stored thereon, which, when executed by the processor, causes the system to perform operations. The operations include generating a plurality of trading bots. Each trading bot includes a plurality of parameters that characterize the trading bot. The plurality of parameters defines execution rules for the trading bot. The operations further include retrieving historical data associated with a financial asset from one or more third party systems. The operations further include searching the plurality of trading bots for an initial ideal trading bot that tracks a performance of the financial asset based on the historical data. The operations further include deploying the initial ideal trading bot for a first duration of time. When deployed, the initial ideal trading bot executes the execution rules associated with the plurality of parameters that define the initial ideal trading bot. The operations further include evaluating the performance of the initial ideal trading bot for the first duration of time. The operations further include, based on the evaluating, searching the plurality of trading bots based on the initial ideal trading bot. The searching includes favoring a first set of trading bots that are similar to the initial ideal trading bot or penalizing the first set of trading bots that are similar to the initial ideal trading bot. The operations further include, based on the searching, deploying a new ideal trading bot for a second duration of time.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computing environment, according to one exemplary embodiment.

FIG. 2 is a block diagram illustrating back-end computing system of FIG. 1, according to example embodiments.

FIG. 3 is a flow diagram illustrating a method of generating and deploying a trading bot, according to example embodiments.

FIG. 4A illustrates a system bus computing system architecture, according to example embodiments.

FIG. 4B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The 2020's has been marked by the emergence of powerful, scalable computing systems. Such emergence has enabled computer scientists to apply modern, theoretical machine learning concepts to real-world problems. For example, while a multi-layered neural network was theoretically worked out decades prior, it was not until the emergence of more powerful, scalable computing systems that a multi-layered neural network could be applied in practice due to its computational complexity. In recent years, the same approach has been re-introduced as “deep learning.” Deep learning techniques are now being applied in fundamentally important problems, such as facial recognition, with tremendous success.

One or more techniques described herein provides a novel application of machine learning techniques to create an automated system for financial asset (e.g., cryptocurrency) trading with maximal returns. For example, one or more techniques described herein provide a financial asset trading platform that is defined by two components: (1) a framework for defining trading strategies; and (2) a machine-learning based approach for finding the optimal strategy under the framework. Such financial trading platform may be agnostic to the specific machine learning techniques utilized, the asset being traded, and the details of the computational architecture used to execute trades.

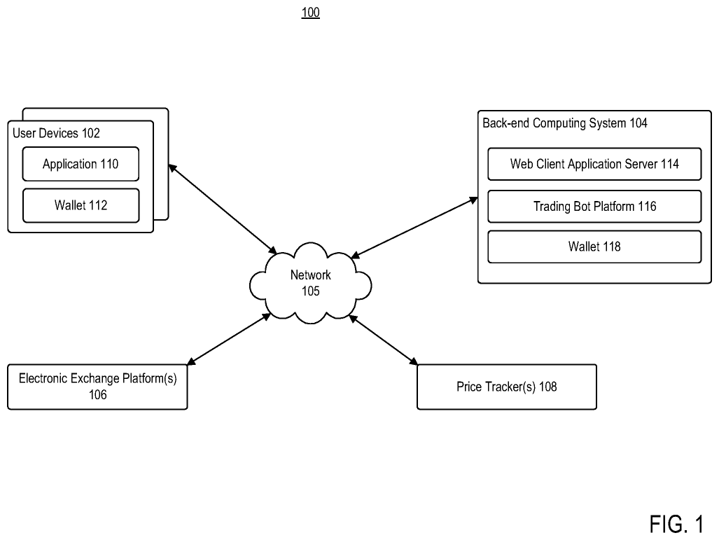

FIG. 1 is a block diagram illustrating computing environment 100, according to one embodiment. Computing environment 100 may include at least one or more user devices 102, a back-end computing system 104, an electronic exchange platform 106, and a financial asset price tracker (“price tracker”) 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user or customer of an entity associated with back-end computing system 104. User device 102 may be representative of a mobile device, a tablet, a desktop computer, or any computing system having the capabilities described herein. In some embodiments, a user of user device 102 may be representative of a user who has transferred assets to an organization associated with back-end computing system 104, such that back-end computing system 104 can automatically manage the user's transferred assets.

User device 102 may include at least application 110. In some embodiments, application 110 may be representative of an application associated with back-end computing system 104. In some embodiments, application 110 may be a standalone application associated with back-end computing system 104. In some embodiments, application 110 may be representative of a web-browser configured to communicate with back-end computing system 104. In some embodiments, user device 102 may communicate over network 105 to request a webpage, for example, from web client application server 114 of back-end computing system 104. For example, user device 102 may be configured to execute application 110 to access the user's account with back-end computing system 104. The content that is displayed to user device 102 may be transmitted from web client application server 114 to user device 102, and subsequently processed by application 110 for display through a graphical user interface (GUI) of user device 102.

In some embodiments, user device 102 may further include wallet 112. Wallet 112 may be representative of a device, medium, service, or digital storage location that is configured to store key pairs associated with a user's blockchain account for cryptocurrency transactions. In some embodiments, wallet 112 may be stored locally to user device 102. In some embodiments, wallet 112 may be representative of an externally stored wallet. In operation, a user of user device 102 may transfer cryptocurrency from a user's cryptocurrency account using the key pairs stored in wallet 112.

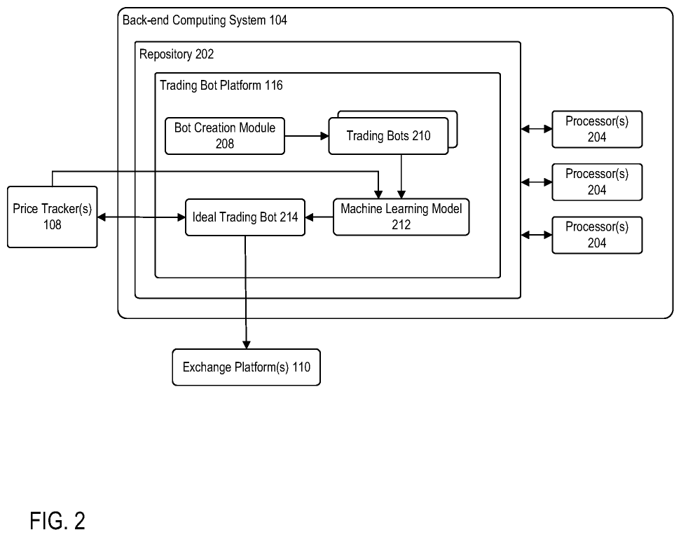

Back-end computing system 104 may include web client application server 114 and trading platform 116. Trading platform 116 may be configured to automatically manage a user's cryptocurrency or financial asset portfolio. For example, a user may provide financial assets to trading platform 116, such that trading platform 116 can manage the user's financial assets. In some embodiments, managing a user's financial assets may include the buying, selling, and trading of financial assets, such as a cryptocurrency (e.g., Bitcoin, Ethereum, Litecoin, Ripple, etc.). The details of trading platform 116 are discussed in further detail below in conjunction with FIG. 2.

Electronic exchange platform 106 may be representative of one or more electronic exchanges. Exemplary electronic exchanges may include, but are not limited to, New York Stock Exchange, NASDAQ, Robinhood, and the like. In some embodiments, electronic exchange platform 106 may be representative of one or more cryptocurrency exchanges. Exemplary cryptocurrency exchanges may include, but are not limited to, Binance. Coinbase, FTX, Kraken, and the like. In operation, trading platform 116 may communicate with an electronic exchange platform 106 via one or more application programming interfaces (API) of electronic exchange platform 106 to buy, sell, or execute a trade of cryptocurrency on behalf of a user.

In some embodiments, back-end computing system 104 may include wallet 118. Wallet 118 may be configured similarly to wallet 112 on a user device 102. In operation, when a user initiates an account with back-end computing system 104, a user may transfer cryptocurrency from a user's cryptocurrency account to a cryptocurrency account associated with back-end computing system 104.

Price trackers 108 may be representative of one or more servers or systems configured to track the prices of various financial assets. Exemplary financial asset price trackers 108 include, but are not limited to, Yahoo Finance, MarketWatch, and the like. In some embodiments, price trackers 108 may be representative of one or more servers or systems configured to track the prices of cryptocurrency. Exemplary cryptocurrency price trackers 108 may include, but are not limited to, Coinbase, CoinMarketCap, Coinlib, Coindesk, and the like. In operation, trading platform 116 may be configured to monitor one or more price trackers 108 while managing the user's financial asset portfolio. In this manner, trading platform 116 may learn the trends of the various financial assets, as well as determine when to buy, sell, or trade the user's financial assets.

FIG. 2 is a block diagram illustrating back-end computing system 104, according to example embodiments. As shown, back-end computing system 104 includes repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least trading platform 116.

Trading platform 116 may include bot creation module 208 and machine learning module 212. Each of bot creation module 208 and machine learning module 212 may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Bot creation module 208 may be configured to generate one or more trading bots 210 for use in trading platform 116. Generally, a trading bot 210 may be defined as a software-based program or script configured to monitor cryptocurrency price trackers 108 for determining when to perform an action on a user's portfolio. In some embodiments, trading bot 210 may be thought of as a fictitious trader that follows a trading strategy defined by various rules. In some embodiments, the rules each trading bot 210 follow include:

(1) if an asset is not owned, buy an asset if the price has dropped by

$$\frac{{Δ}_{b u y} \%}{{t}_{buy}} ;$$

(2) if an asset is owned, sell that asset if the price (a) rises by

$$\frac{{Δ}_{r i s e} \%}{{t}_{r i s e}} ,$$

or (b) falls by

$$\frac{{Δ}_{fall} \%}{{t}_{fall}} ,$$

where

$$\frac{{Δ}_{b u y} \%}{{t}_{buy}}$$

corresponds to a percent change threshold over time for buying an unowned asset,

$$\frac{{Δ}_{r i s e} \%}{{t}_{r i s e}} ,$$

corresponds to a percent change threshold over time for selling an owned asset if the price is rising,

$$\frac{{Δ}_{fall} \%}{{t}_{fall}}$$

corresponds to a percent change threshold, where t_{buy} represents the time variable for buying an asset, tᵣᵢₛₑ corresponds to the time variable for selling a rising asset, and t_{fall} corresponds to the time variable for selling a falling asset.

In other words, each trading bot 210 may be configured to buy an asset when the price is low (e.g., rule 1) and sell that asset when the price rises to make money (e.g., rule 2a) or falls to cur losses (e.g., rule 2b). Further, each trading bot 210 can act on these rules over shorter time horizons similar to a day trading by reducing t_{buy}, tᵣᵢₛₑ, and t_{fall} or longer time horizons like a position trader by increasing t_{buy}, tᵣᵢₛₑ, and t_{fall}.

In some embodiments, bot creation module 208 may be configured to generate a plurality of trading bots 210. In some embodiments, the number of trading bots 210 may be administrator defined. Each trading bot 210 may be characterized by one or more parameters. For example, each trading bot 210 may be characterized by six parameters that include: Δ_{buy}, Δᵣᵢₛₑ, Δ_{fall}, t_{buy}, t_{Rise}, t_{fall}. In other words, each trading bot 210 of the plurality of trading bots may include a unique set of six parameters that characterize that trading bot 210.

A trading bot's 210 performance after some time T may be measured by the value of its portfolio P_{T}. For example, starting with an initial portfolio value P₀, after some time T, the value of the trading bot's 210 portfolio can be approximated by:

P_{T}≈P₀(1+Δᵣᵢₛₑ)^{N}^{ᵣᵢₛₑ}(1−Δ_{fall})^{N}^{_{fall}}

where Nᵣᵢₛₑ represents the number of trades made under rising price conditions and N_{fall} represents the number of trades made under falling price conditions.

Although not explicitly shown, there may exist a plurality of trading bots 210 for each type of financial asset.

Such framework provides an improvement over conventional systems. For example, conventional models in quantitative finance treat asset prices as a random variable with statistically regular properties. Such approach faces two major challenges. First, while such models may be able to predict the magnitude of changes in asset prices, they often fail to predict the direction of the change. This limitation presents a major challenge for asset trading, because, to make money, a trader typically needs to find arbitrage opportunities, which typically requires the ability to predict the direction in which asset prices are falling. Second, another assumption built into conventional models is that asset prices empirically follow a log-normal or “fat-tailed” distribution. Unfortunately, an important property of fat-tailed distributions is the uncharacteristically high frequency of rare, or “black swan” events. An example of a rare event is an asset price crash, which could wipe out several years' worth of modest gains in an instant.

The present framework underling trading bots 210 is immune to the challenges that plague conventional systems. For example, unlike the conventional, more complicated, models that make strong statistical assumptions about asset prices (e.g., log-normally distributed), trading bots 210 are configured to make a single assumption: that the asset price is a random variable that fluctuates over time. Through such simplicity, trading bots 210 do not include the critical failure points of conventional systems, i.e., the difficulty of finding arbitrage opportunities and the need to protect against the occurrence of rare events.

Machine learning module 212 may be configured to identify an ideal trading bot 214 for a financial asset. For example, because P_{T} is a convex function, it can be shown that there is an ideal trading bot 214, which may be defined by the set of parameters that maximizes the portfolio value, P_{T}. Machine learning module 212 may be trained to continually update the ideal trading bot 214 based on historical pricing data for the financial asset.

In some embodiments, machine learning module 212 may utilize a reinforcement learning algorithm. For example, machine learning module 212 may continually update ideal trading bot 214 using reinforcement learning techniques. In operation, machine learning module 212 may retrieve historical pricing data associated with a financial asset. For example, machine learning module 212 may retrieve historical pricing data for a given cryptocurrency (e.g., Bitcoin) from price tracker 108. In some embodiments, the historical pricing data may include historical pricing data for financial assets similar to the target financial asset. For example, the historical pricing data for Bitcoin may also include historical pricing data for Ethereum, since the price of Ethereum tends to track the price of Bitcoin. Based on the historical pricing data for the financial asset, machine learning module 212 may search for an ideal trading bot from the plurality of generated trading bots 210.

In some embodiments, the process of searching for ideal trading bot 214 can be accomplished through one or more convex search methods. In some embodiments, if the limits of the parameter space are known, then a grid search or other exhaustive search can be used. In some embodiments, if the parameter space is large and multidimensional, a biased random search such as the Metropolis-Hastings algorithm can be used.

After identifying an ideal trading bot, machine learning module 212 may implement that trading bot for some time, t. Machine learning module 212 may then search for a new ideal trading bot based on the historical pricing data plus the pricing data from the additional period, t. If the performance of the initial ideal trading bot exceeded a threshold tolerance, then machine learning module 212 may bias the search for the new ideal trading bot based on the initial ideal trading bot. Conversely, if the performance of the initial ideal trading bot did not meet a minimum threshold, then machine learning module 212 can penalize trading bots that are similar to the initial ideal trading bot. Machine learning module 212 may then utilize a bias function to reinforce good results. For example, in some embodiments, the search can be biased towards new trading bots that resemble a prior trading bot by penalizing root mean square deviations between the parameters of the new and prior trading bots. As output, machine learning module 212 may provide an ideal trading bot 214 to manage the user's financial asset portfolio.

As those skilled in the art understand, machine learning module 212 may routinely update ideal trading bot 214 based on updated pricing information. In this manner, machine learning module 212 can continually learn and incorporate evolving market characteristics into the trading strategy, thus removing any need for human interaction.

Once output, ideal trading bot 214 may be deployed to manage the user financial asset portfolio. For example, ideal trading bot 214 may monitor the price of a financial asset (in real-time or near real-time) and initiate a buy, sell, or trade based on the set of parameters that characterize ideal trading bot 214. When a trigger event occurs (as dictated by the set of parameters), ideal trading bot 214 may access one or more electronic exchange platforms 106 to initiate a buy, sell, or trade on behalf of the user.

Although not explicitly shown, there may exist a plurality of ideal trading bots 214 for each type of financial asset.

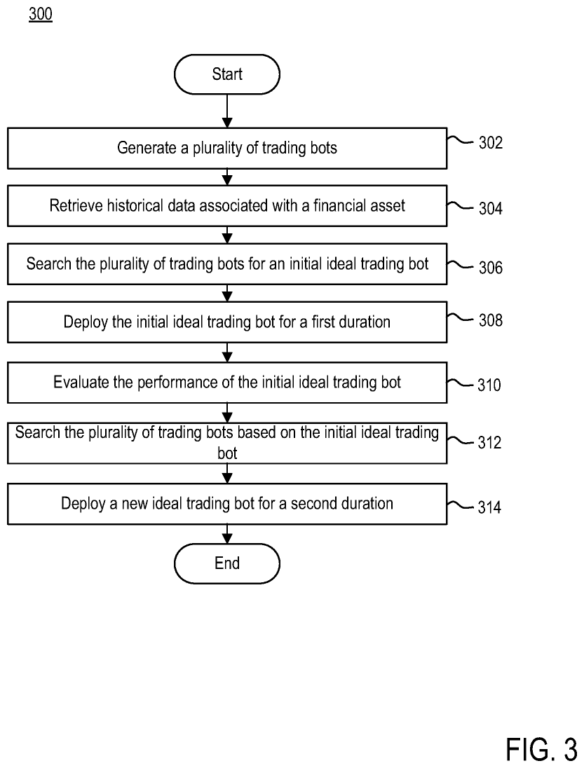

FIG. 3 is a flow diagram illustrating a method 300 of generating and deploying a trading bot, according to example embodiments. Method 300 may begin at step 302.

At step 302, back-end computing system 104 may generate a plurality of trading bots. For example, bot creation module 208 may generate a plurality of trading bots 210. In some embodiments, the number of trading bots 210 may be administrator defined. Each trading bot 210 may be characterized by one or more parameters. For example, each trading bot 210 may be characterized by six parameters that include: Δ_{buy}, Δᵣᵢₛₑ, Δ_{fall}, t_{buy}, t_{Rise}, t_{fall}. In other words, each trading bot 210 of the plurality of trading bots may include a unique set of six parameters that characterize that trading bot 210.

At step 304, back-end computing system 104 may retrieve historical data associated with a financial asset. In some embodiments, computing system 104 may interface with one or more third party systems to retrieve the historical data. For example, back-end computing system 104 may retrieve historical pricing data for a given cryptocurrency (e.g., Bitcoin) from cryptocurrency price tracker 108. In some embodiments, the historical pricing data may include historical pricing data for financial assets similar to the target financial asset.

At step 306, back-end computing system 104 may search the plurality of trading bots for an initial ideal trading bot. The initial ideal trading bot may be representative of a trading bot from the plurality of trading bots that tracks a performance of the financial asset the best. For example, in some embodiments, machine learning module 212 may to identify an ideal trading bot for a financial asset based on the convex function P_{T}.

At step 308, back-end computing system 104 may deploy the initial ideal trading bot for a first duration of time. During the first duration of time, the ideal trading bot may execute execution rules associated with the plurality of parameters that define the initial ideal trading bot.

At step 310, back-end computing system 104 may evaluate the performance of the initial ideal trading bot during the first duration of time. A trading bot's performance after some time T may be measured by the value of its portfolio P_{T}. For example, starting with an initial portfolio value P₀, after some time T, the value of the trading bot's 210 portfolio can be approximated by:

P_{T}≈P₀(1+Δᵣᵢₛₑ)^{N}^{ᵣᵢₛₑ}(1−Δ_{fall})^{N}^{_{fall}}

where Nᵣᵢₛₑ represents the number of trades made under rising price conditions and N_{fall} represents the number of trades made under falling price conditions.

At step 312, back-end computing system 104 may search the plurality of trading bots based on an initial ideal trading bot for a new ideal trading bot. For example, depending on the performance of the initial ideal trading bot, back-end computing system 104 may identify a new ideal trading bot that is either similar to the initial ideal trading bot (e.g., the initial ideal trading bot satisfied a threshold level of performance) or different from the initial ideal trading bot (e.g., the initial ideal trading bot did not satisfy a threshold level of performance). Similar to step 306, the new ideal trading bot may be representative of a trading bot from the plurality of trading bots that tracks a performance of the financial asset the best. For example, in some embodiments, machine learning module 212 may to identify a new ideal trading bot for a financial asset based on the convex function P_{T}.

At step 314, back-end computing system 104 may deploy the new ideal trading bot for a second duration of time. During the second duration of time, the new ideal trading bot may execute execution rules associated with the plurality of parameters that define the new ideal trading bot.

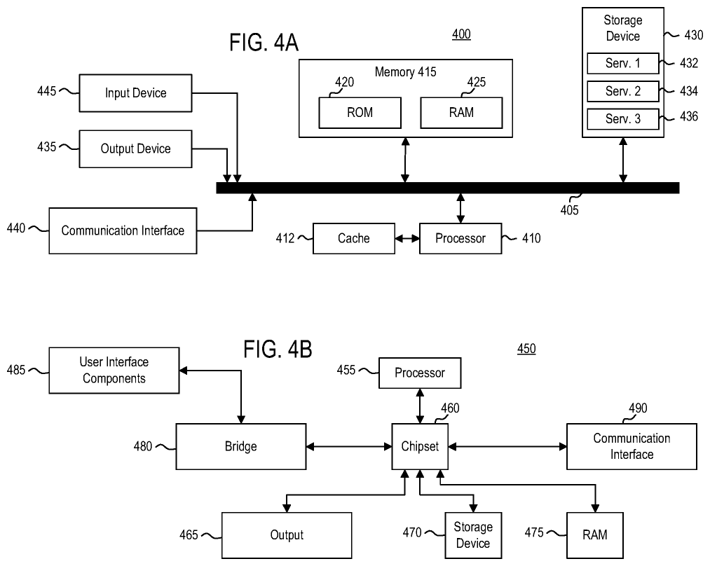

FIG. 4A illustrates an architecture of system bus computing system 400, according to example embodiments. One or more components of system 400 may be in electrical communication with each other using a bus 405. System 400 may include a processor (e.g., one or more CPUs, GPUs or other types of processors) 410 and a system bus 405 that couples various system components including the system memory 415, such as read only memory (ROM) 420 and random access memory (RAM) 425, to processor 410. System 400 can include a cache of high-speed memory connected directly with, in close proximity to, or integrated as part of processor 410. System 400 can copy data from memory 415 and/or storage device 430 to cache 412 for quick access by processor 410. In this way, cache 412 may provide a performance boost that avoids processor 410 delays while waiting for data. These and other modules can control or be configured to control processor 410 to perform various actions. Other system memory 415 may be available for use as well. Memory 415 may include multiple different types of memory with different performance characteristics. Processor 410 may be representative of a single processor or multiple processors. Processor 410 can include one or more of a general purpose processor or a hardware module or software module, such as service 1 432, service 2 434, and service 4 436 stored in storage device 430, configured to control processor 410, as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction with the system 400, an input device 445 can be any number of input mechanisms, such as a microphone for speech, a touch-sensitive screen for gesture or graphical input, keyboard, mouse, motion input, speech and so forth. An output device 435 (e.g., a display) can also be one or more of a number of output mechanisms known to those of skill in the art. In some instances, multimodal systems can enable a user to provide multiple types of input to communicate with system 400. Communication interface 440 can generally govern and manage the user input and system output. There is no restriction on operating on any particular hardware arrangement and therefore the basic features here may easily be substituted for improved hardware or firmware arrangements as they are developed.

Storage device 430 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 425, read only memory (ROM) 420, and hybrids thereof.

Storage device 430 can include services 432, 434, and 436 for controlling the processor 410. Other hardware or software modules are contemplated. Storage device 430 can be connected to system bus 405. In one aspect, a hardware module that performs a particular function can include the software component stored in a computer-readable medium in connection with the necessary hardware components, such as processor 410, bus 405, output device 435 (e.g., a display), and so forth, to carry out the function.

FIG. 4B illustrates a computer system 450 having a chipset architecture, according to example embodiments. Computer system 450 may be an example of computer hardware, software, and firmware that can be used to implement the disclosed technology. System 450 can include one or more processors 455, representative of any number of physically and/or logically distinct resources capable of executing software, firmware, and hardware configured to perform identified computations. One or more processors 455 can communicate with a chipset 460 that can control input to and output from one or more processors 455. In this example, chipset 460 outputs information to output 465, such as a display, and can read and write information to storage device 470, which can include magnetic media, and solid-state media, for example. Chipset 460 can also read data from and write data to storage device 475 (e.g., RAM). A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 455 analyzing data stored in storage device 470 or 475. Further, the machine can receive inputs from a user through user interface components 485 and execute appropriate functions, such as browsing functions by interpreting these inputs using one or more processors 455.

It can be appreciated that example systems 400 and 450 can have more than one processor 410 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
generating, by a computing system, a plurality of trading bots, each trading bot comprising a plurality of parameters that characterize the trading bot, the plurality of parameters defining execution rules for the trading bot;
retrieving, by the computing system, historical data associated with a financial asset from one or more third party systems;
searching, by the computing system, the plurality of trading bots for an initial ideal trading bot that tracks a performance of the financial asset based on the historical data;
deploying, by the computing system, the initial ideal trading bot for a first duration of time, wherein, when deployed, the initial ideal trading bot executes the execution rules associated with the plurality of parameters that define the initial ideal trading bot;
evaluating, by the computing system, the performance of the initial ideal trading bot for the first duration of time;
based on the evaluating, searching, by the computing system, the plurality of trading bots based on the initial ideal trading bot, wherein the searching comprises favoring a first set of trading bots that are similar to the initial ideal trading bot or penalizing the first set of trading bots that are similar to the initial ideal trading bot; and
based on the searching, deploying, by the computing system, a new ideal trading bot for a second duration of time.

2. The method of claim 1, wherein searching, by the computing system, the plurality of trading bots for the initial ideal trading bot comprises:
determining that the initial ideal trading bot maximizes a convex function associated with its task.

3. The method of claim 1, further comprising:
updating, by the computing system, the initial ideal trading bot based on historical pricing data.

4. The method of claim 3, wherein updating, by the computing system, the initial ideal trading bot based on historical pricing comprises:
retrieving the historical pricing of a target asset; and
updating the initial ideal trading bot by applying reinforcement learning techniques to the historical pricing of the target asset.

5. The method of claim 1, wherein searching, by the computing system, the plurality of trading bots based on the initial ideal trading bot comprises:
applying a cost optimization algorithm to the plurality of trading bots to identify the new ideal trading bot.

6. The method of claim 1, further comprises:
determining, by the computing system, that the new ideal trading bot did not meet a minimum performance threshold; and
based on the determining, re-searching, the plurality of trading bots based on the new ideal trading bot, wherein the re-searching is biased away from the new ideal trading bot.

7. The method of claim 1, further comprising:
determining, by the computing system, that the new ideal trading bot did meet a minimum performance threshold; and
based on the determining, re-searching, by the computing system, the plurality of trading bots based on the new ideal trading bot, wherein the re-searching is biased towards additional trading bots that are similar to the new ideal trading bot.

8. A non-transitory computer readable medium comprising one or more sequences of instructions, which, when executed by one or more processors, causes a computing system to perform operations comprising:
generating, by the computing system, a plurality of trading bots, each trading bot comprising a plurality of parameters that characterize the trading bot, the plurality of parameters defining execution rules for the trading bot;
retrieving, by the computing system, historical data associated with a financial asset from one or more third party systems;
searching, by the computing system, the plurality of trading bots for an initial ideal trading bot that tracks a performance of the financial asset based on the historical data;
deploying, by the computing system, the initial ideal trading bot for a first duration of time, wherein, when deployed, the initial ideal trading bot executes the execution rules associated with the plurality of parameters that define the initial ideal trading bot;
evaluating, by the computing system, the performance of the initial ideal trading bot for the first duration of time;
based on the evaluating, searching, by the computing system, the plurality of trading bots based on the initial ideal trading bot, wherein the searching comprises favoring a first set of trading bots that are similar to the initial ideal trading bot or penalizing the first set of trading bots that are similar to the initial ideal trading bot; and
based on the searching, deploying, by the computing system, a new ideal trading bot for a second duration of time.

9. The non-transitory computer readable medium of claim 8, wherein searching, by the computing system, the plurality of trading bots for the initial ideal trading bot comprises:
determining that the initial ideal trading bot maximizes a convex function associated with its task.

10. The non-transitory computer readable medium of claim 8, further comprising:
updating, by the computing system, the initial ideal trading bot based on historical pricing data.

11. The non-transitory computer readable medium of claim 10, wherein updating, by the computing system, the initial ideal trading bot based on historical pricing comprises:
retrieving the historical pricing of a target asset; and
updating the initial ideal trading bot by applying reinforcement learning techniques to the historical pricing of the target asset.

12. The non-transitory computer readable medium of claim 8, wherein searching, by the computing system, the plurality of trading bots based on the initial ideal trading bot comprises:
applying a cost optimization algorithm to the plurality of trading bots to identify the new ideal trading bot.

13. The non-transitory computer readable medium of claim 8, further comprises:
determining, by the computing system, that the new ideal trading bot did not meet a minimum performance threshold; and
based on the determining, re-searching, the plurality of trading bots based on the new ideal trading bot, wherein the re-searching is biased away from the new ideal trading bot.

14. The non-transitory computer readable medium of claim 8, further comprising:
determining, by the computing system, that the new ideal trading bot did meet a minimum performance threshold; and
based on the determining, re-searching, by the computing system, the plurality of trading bots based on the new ideal trading bot, wherein the re-searching is biased towards additional trading bots that are similar to the new ideal trading bot.

15. A system comprising:
a processor; and
a memory having programming instructions stored thereon, which, when executed by the processor, causes the system to perform operations comprising:
generating a plurality of trading bots, each trading bot comprising a plurality of parameters that characterize the trading bot, the plurality of parameters defining execution rules for the trading bot;
retrieving historical data associated with a financial asset from one or more third party systems;
searching the plurality of trading bots for an initial ideal trading bot that tracks a performance of the financial asset based on the historical data;
deploying the initial ideal trading bot for a first duration of time, wherein, when deployed, the initial ideal trading bot executes the execution rules associated with the plurality of parameters that define the initial ideal trading bot;
evaluating the performance of the initial ideal trading bot for the first duration of time;
based on the evaluating, searching the plurality of trading bots based on the initial ideal trading bot, wherein the searching comprises favoring a first set of trading bots that are similar to the initial ideal trading bot or penalizing the first set of trading bots that are similar to the initial ideal trading bot; and
based on the searching, deploying a new ideal trading bot for a second duration of time.

16. The system of claim 15, wherein searching the plurality of trading bots for the initial ideal trading bot comprises:
determining that the initial ideal trading bot maximizes a convex function associated with its task.

17. The system of claim 15, wherein the operations further comprise:
updating the initial ideal trading bot based on historical pricing data, the updating comprising:
retrieving the historical pricing of a target asset; and
updating the initial ideal trading bot by applying reinforcement learning techniques to the historical pricing of the target asset.

18. The system of claim 15, wherein searching the plurality of trading bots based on the initial ideal trading bot comprises:
applying a cost optimization algorithm to the plurality of trading bots to identify the new ideal trading bot.

19. The system of claim 15, wherein the operations further comprise:
determining that the new ideal trading bot did not meet a minimum performance threshold; and
based on the determining, re-searching, the plurality of trading bots based on the new ideal trading bot, wherein the re-searching is biased away from the new ideal trading bot.

20. The system of claim 15, wherein the operations further comprise:
determining that the new ideal trading bot did meet a minimum performance threshold; and
based on the determining, re-searching the plurality of trading bots based on the new ideal trading bot, wherein the re-searching is biased towards additional trading bots that are similar to the new ideal trading bot.
